(19) United States
(12) Patent Application Publication
(10) Pub. No.: US 2024/0319431 A1
(43) Pub. Date: Sep. 26, 2024

(54) DISPLAY DEVICE AND MANUFACTURING METHOD OF THE SAME

(71) Applicant: E Ink Holdings Inc., HSINCHU (TW)

(72) Inventor: Yi-Yu TSAI, HSINCHU (TW)

(21) Appl. No.: 18/608,954

(22) Filed: Mar. 19, 2024

Related U.S. Application Data
(60) Provisional application No. 63/453,171, filed on Mar. 20, 2023.

(51) Int. Cl. F21V 8/00; G02B 27/00

(52) U.S. Cl. CPC G02B 6/0088; G02B 6/0065; G02B 27/0025

(57) ABSTRACT

A display device includes a reflective display panel, a light guide plate, a first resin layer, a second resin layer, and a first optical adhesive layer. The light guide plate has a top surface and a bottom surface. The first resin layer includes a light guide entrance and a leveled region. The first resin layer is located on the bottom surface. The second resin layer is located on the top surface and has a microstructure. The first optical adhesive layer is located between the reflective display panel and the light guide plate. The refractive index of the leveled region of the first resin layer and the refractive index of the first optical adhesive layer are the same.

### CROSS-REFERENCE TO RELATED APPLICATION

This application claims priority to U.S. Provisional Application Ser. No. 63/453,171, filed Mar. 20, 2023, which is herein incorporated by reference in its entirety.

### BACKGROUND

### Field of Invention

The present invention relates to a display device and a manufacturing method of the display device.

### Description of Related Art

As the demand for thinned and flexible display increases, the thickness of the light guide plate decreases as well. However, a light entrance area is reduced due to thinned light guide plate. Therefore, layers for improving light entrance efficiency are required. As a result, the fringes caused by processing defects due to refractive index difference between different layers may appear on the display screen when the light passes through those layers.

Accordingly, it is still a development direction for the industry to provide a display device that can solve the problems mentioned above.

### SUMMARY

One aspect of the present invention is a display device.

In one embodiment, the display device includes a reflective display panel, a light guide plate, a first resin layer, a second resin layer, and a first optical adhesive layer. The light guide plate has a top surface and a bottom surface. The first resin layer includes a light guide entrance and a leveled region. The first resin layer is located on the bottom surface. The second resin layer is located on the top surface and has a microstructure. The first optical adhesive layer is located between the reflective display panel and the light guide plate. The refractive index of the leveled region of the first resin layer and the refractive index of the first optical adhesive layer are the same.

In one embodiment, the thickness of the light guide plate is less than 250 micrometers.

In one embodiment, the refractive index of the first resin layer is in a range from 1.45 to 1.51.

In one embodiment, the refractive index of the light guide entrance of the first resin layer is the same as the refractive index of the first optical adhesive layer.

In one embodiment, the refractive index of the first resin layer is different from the refractive index of the second resin layer.

In one embodiment, the refractive index of the second resin layer is the same as the refractive index of the light guide plate.

In one embodiment, the refractive index of the first resin layer is smaller than the refractive index of the light guide plate.

In one embodiment, the display device further includes a cover having a display area and a non-display area. An orthogonal projection of the leveled region of the first resin layer on the cover is in the display area.

In one embodiment, an orthogonal projection of the light guide entrance of the first resin layer on the cover is located in the non-display area.

In one embodiment, the thickness of the leveled region is smaller than the thickness of the light guide entrance.

In one embodiment, the display device further includes a light source disposed at a light incident surface of the light guide plate, and the light guide entrance is located at a side of the first resin layer adjacent to the light incident surface.

Another aspect of the present invention is a manufacturing method of a display device.

In one embodiment, the manufacturing method includes coating a first resin layer on a lower surface of a light guide plate; embossing the first resin layer with a mold to form a light guide entrance and a leveled region; and adhering the first resin layer and a reflective display panel through a first optical adhesive layer, wherein the refractive index of the first optical adhesive layer is the same as the refractive index of the first resin layer.

In one embodiment, the manufacturing method of the display device further includes leveling the mold through a knife.

In one embodiment, the first resin layer does not have a microstructure for guiding light to the reflective display panel.

In one embodiment, the manufacturing method of the display device further includes coating a second resin layer on an upper surface of the light guide plate, wherein the refractive index of the second resin layer is different from the refractive index of the first resin layer; and forming a microstructure on the second resin layer.

In one embodiment, the manufacturing method of the display device further includes making the refractive index of the second resin layer the same as the refractive index of the light guide plate.

In one embodiment, the manufacturing method of the display device further includes adhering a second resin layer and a touch panel through a second optical adhesive layer.

In one embodiment, the manufacturing method of the display device further includes disposing a cover having a display area and a non-display area, and an orthogonal projection of the light guide entrance of the first resin layer on the cover is in the non-display area.

In one embodiment, the manufacturing method of the display device further includes making an orthogonal projection of the leveled region of the first resin layer on the cover in the display area.

In one embodiment, the manufacturing method of the display device further includes disposing a light source at a light incident surface of the light guide plate, wherein the light guide entrance is located at a side of the first resin layer adjacent to the light incident surface.

In aforementioned embodiments, the resin layers are provided on opposite sides of a thinned light guide plate with a light guide entrance. the first resin layer disposed between the light guide plate and the reflective display panel of the present disclosure is used to form the light guide entrance of the thinned light guide plate, and therefore the fringes appear on the display screen caused by the refraction of the light due to knife marks or processing defects on the first resin layer can be eliminated by matching the refractive index of the first resin layer and the refractive index of the optical adhesive layer.

### BRIEF DESCRIPTION OF THE DRAWINGS

The invention can be more fully understood by reading the following detailed description of the embodiment, with reference made to the accompanying drawings as follows:

FIG. 1 is a side view of a display device according to one embodiment of the present disclosure.

FIG. 2 is another side view of the display device in FIG. 1.

FIG. 3 to FIG. 7 are side views of the intermediate steps of a manufacturing method of the display device in FIG. 1.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

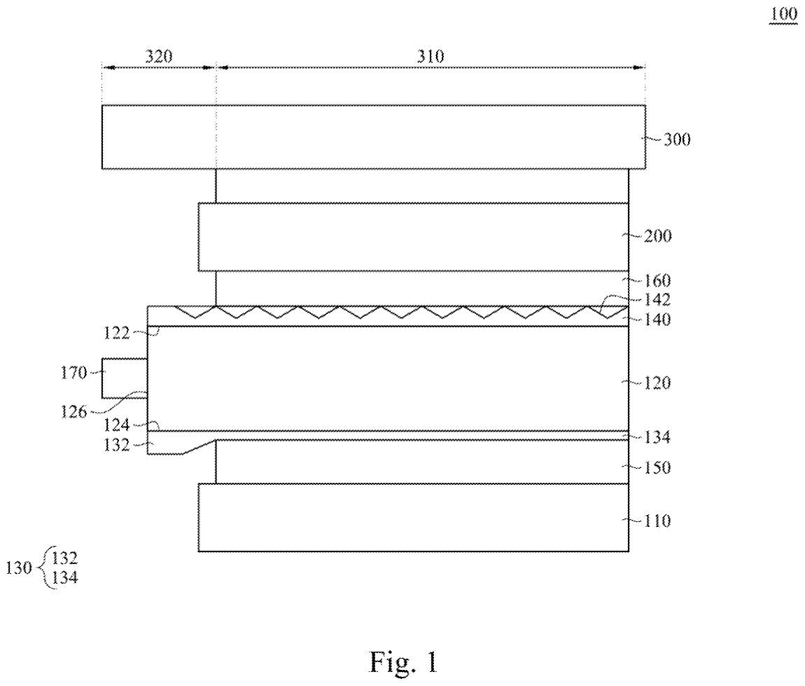

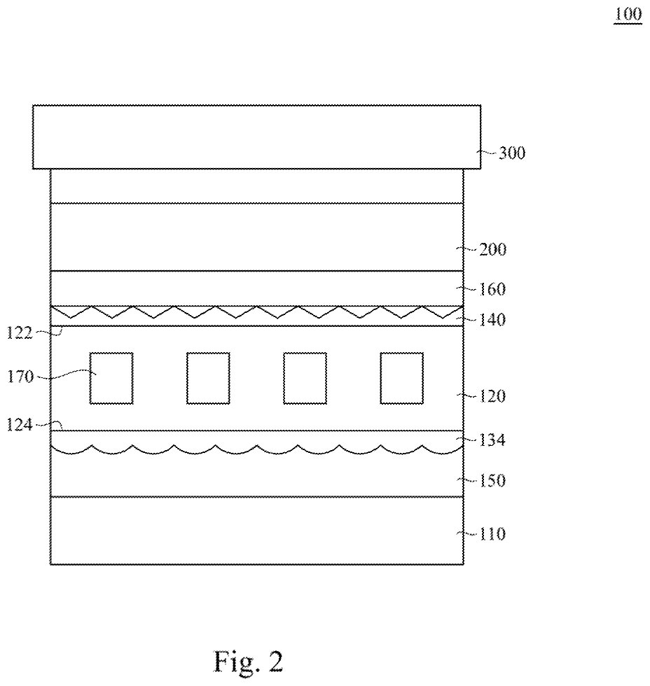

FIG. 1 is a side view of a display device 100 according to one embodiment of the present disclosure. FIG. 2 is another side view of the display device 100 in FIG. 1. FIG. 2 is taken from the left side toward the right side of FIG. 1. The display device 100 includes a reflective display panel 110, a light guide plate 120, a first resin layer 130, a second resin layer 140, and a first optical adhesive layer 150. The light guide plate 120 has an upper surface 122 and a lower surface 124. The lower surface 124 of the light guide plate 120 faces the reflective display panel 110. The first resin layer 130 is located on the lower surface 124 of the light guide plate 120. The second resin layer 140 is located on the upper surface 122 of the light guide plate 120.

The first resin layer 130 includes a light guide entrance 132 and a leveled region 134. The second resin layer 140 has microstructures 142. The first optical adhesive layer 150 is located between the reflective display panel 110 and the light guide plate 120. The leveled region 134 of the light guide entrance 132 is adhered to the reflective display panel 110 through the first optical adhesive layer 150.

For example, the refractive index of the light guide plate 120 is substantially 1.58. The refractive index of the first optical adhesive layer 150 is in a range from 1.45 to 1.51. The refractive index of the first resin layer 130 of the present disclosure is the same as the refractive index of the first optical adhesive layer 150 and is also in the range from 1.45 to 1.51. In a preferred embodiment, the refractive index of the first resin layer 130 and the refractive index of the first optical adhesive layer 150 are both 1.47.

The refractive index of the second resin layer 140 is the same as the refractive index of the light guide plate 120, which is substantially 1.58. In other words, the refractive index of the first resin layer 130 is different from the refractive index of the second resin layer 140. The refractive index of the first resin layer 130 is smaller than the refractive index of the light guide plate 120.

The light guide entrance 132 and the leveled region 134 of the first resin layer 130 are integrally formed, so the refractive index of the light guide entrance 132 of the first resin layer 130 is the same as the refractive index of the first optical adhesive layer 150.

The display device 100 further includes a second optical adhesive layer 160 disposed on the second resin layer 140. The refractive index of the second optical adhesive layer 160 is the same as the refractive index of the first optical adhesive layer 150.

The light guide plate 120 has a light incident surface 126 connecting the upper surface 122 and the lower surface 124. The display device 100 further includes a light source 170 disposed on the light incident surface 126 of the light guide plate 120. The thickness of the light guide plate 120 is less than 250 micrometers. In a preferred embodiment, the thickness of the light guide plate 120 is about 150 micrometers.

The display device further includes a touch panel 200 and a cover 300. The touch panel 200 is disposed on the second optical adhesive layer 160. The cover 300 includes a display area 310 and a non-display area 320. An orthogonal projection of the leveled region 134 of the first resin layer 130 on the cover 300 is located in the display area 310. An orthogonal projection of the light guide entrance 132 of the first resin layer 130 on the cover 300 is located in the non-display area 320.

The light guide entrance 132 is located on the left side of FIG. 1, which is the side the first resin layer 130 is connected to the light incident surface 126 of the light guide plate 120. The thickness of the leveled region 134 is smaller than the thickness of the light guide entrance 132. The thickness of the light guide entrance 132 gradually decreases from the edge of the first resin layer 130 towards the leveled region 134. The light guide entrance 132 is a horn-shaped inclined structure (taper), which is applied to the thinned light guide plate 120 to increase the efficiency of the light source 170 entering the light guide plate 120.

Since the refractive index of the second resin layer 140 is the same as the refractive index of the light guide plate 120 and is greater than the refractive index of the second optical adhesive layer 160, the microstructures 142 on the second resin layer 140 may improve the effect of light guiding to the reflective display panel 110.

Under the conditions that the refractive index of the first resin layer 130 is greater than the refractive index of the first optical adhesive layer 150 and the thickness of the light guide plate 120 is thin, reflection caused by refractive index difference due to knife mark or processing defects makes fringes (Mura) appear on the display screen when the light passes through the interface between the first resin layer 130 and the first optical adhesive layer 150. In the present disclosure, the refractive index of the leveled region 134 is matched with the refractive index of the first optical adhesive layer 150 such that the reflection does not occur at the interface therebetween, and therefore the fringe due to knife mark or processing defects won't appear on the display screen. Therefore, effects of light guiding and mura elimination are provided by disposing the first resin layer and the second resin layer that have different refractive indexes on opposite two sides of the light guide plate. Alternatively speaking, effects of light guiding and mura elimination are provided simultaneously through disposing two resin layers whose refractive indexes are respectively the same as the refractive index of the optical adhesive layer and the refractive index of the light guide plate.

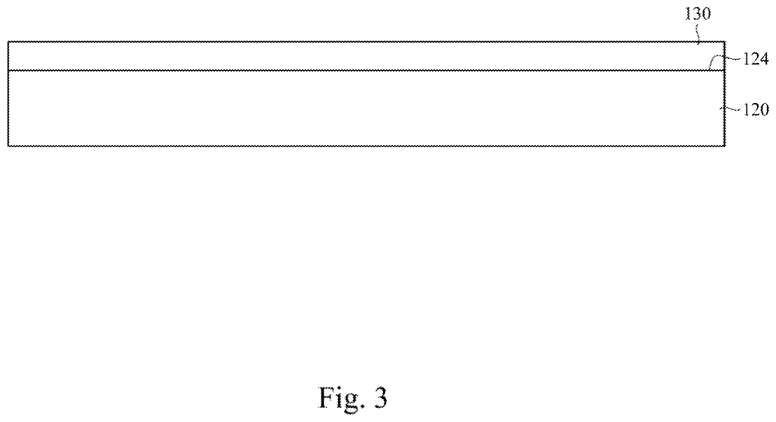

FIG. 3 to FIG. 7 are side views of the intermediate steps of a manufacturing method of the display device 100 in FIG. 1. The structures described above will not be described hereinafter.

Reference is made to FIG. 3. The manufacturing method of the display device includes coating the first resin layer 130 on the lower surface 124 of the light guide plate 120. The material of the first resin layer 130 may be UV resin with a refractive index in a range from 1.45 to 1.51.

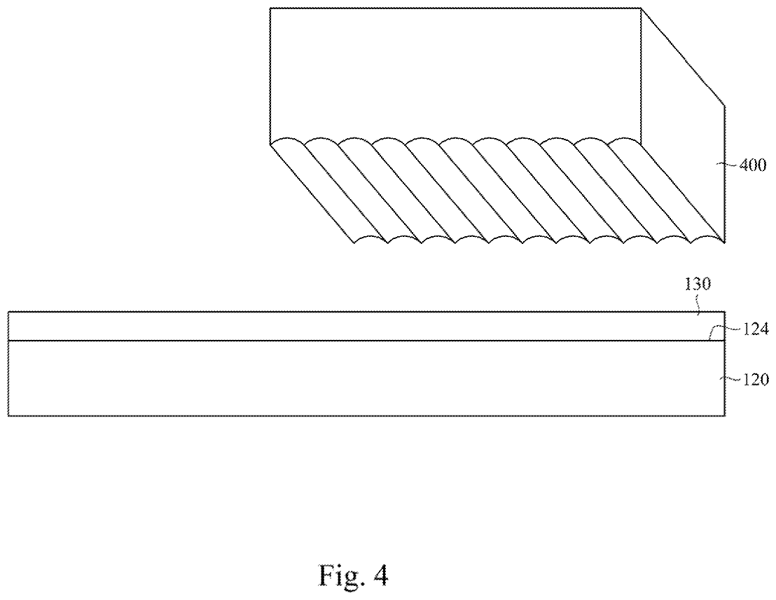

Reference is made to FIG. 4. The manufacturing method of the display device continues to emboss the first resin layer 130 with a mold 400 to form the light guide entrance 132 and the leveled region 134 (see FIG. 1).

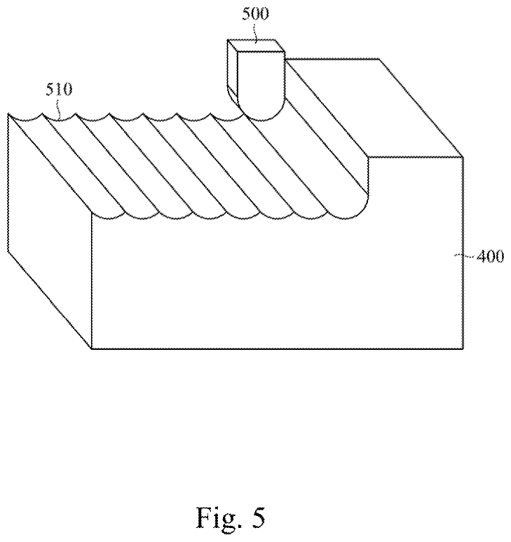

Reference is made to FIG. 5. FIG. 5 is a schematic diagram of the mold 400 used to emboss the first resin layer 130. Before embossing the first resin layer 130 through the mold 400, the mold 400 is leveled through a knife 500. The region which is leveled on the mold 400 corresponds to the leveled region 134 of the first resin layer 130 during the embossing step. In a macroscopic condition, the leveled region on the mold 400 is flat. In a microscopic condition, the leveled region has knife marks 510 produced by the knife 500. However, the mold 400 does not have microstructures that enable the first resin layer 130 to light guiding through embossing the first resin layer 130.

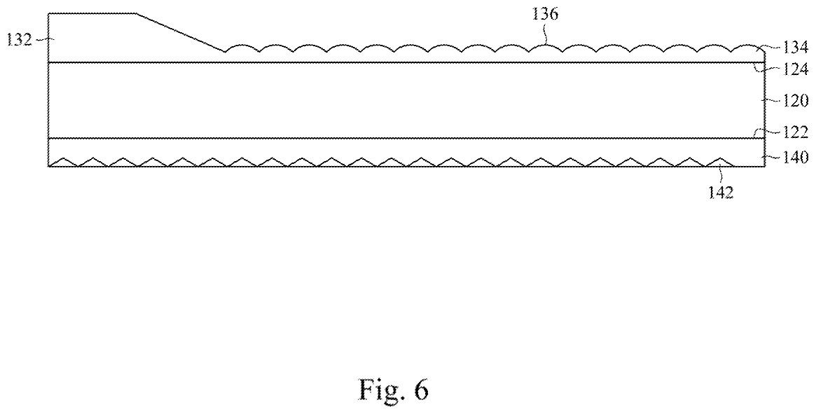

Reference is made to FIG. 6. FIG. 6 is a schematic diagram after the step of embossing the first resin layer 130. In the microscopic condition, the knife marks 136 are transferred onto the leveled region 134 embossed by the mold 400 having the knife marks 510. The knife marks 136 do not have the effect of light guiding. The first resin layer 130 does not have microstructures for light guiding thereon.

Subsequently, forming microstructures 142. The step of forming the microstructures 142 includes coating the second resin layer 140 on the upper surface 122 of the light guide plate 120 and making the refractive index of the second resin layer 140 different from the refractive index of the first resin layer 130. In the present embodiment, the refractive index of the second resin layer 140 is 1.58. Next, the microstructures 142 are formed on the second resin layer 140 through an embossing step. The material of the second resin layer 140 is UV glue. The step of forming the microstructures 142 may be performed before the first resin layer 130 is formed, or may be performed after the first resin layer 130 is formed.

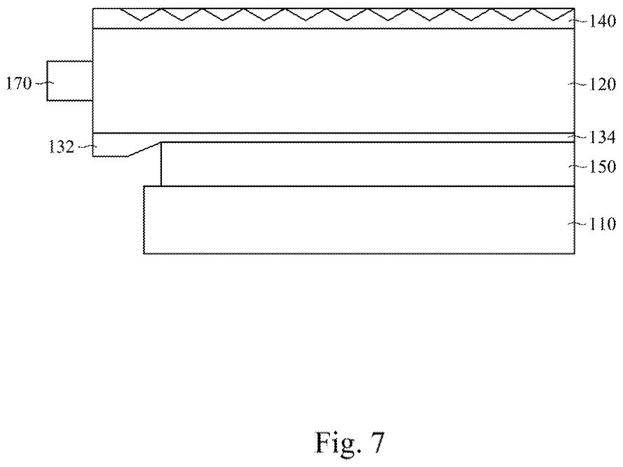

Reference is made to FIG. 7. The manufacturing method of the display device further includes disposing the light source 170 and adhering the first resin layer 130 and the reflective display panel 110 through the first optical adhesive layer 150, and makes the refractive index of the first optical adhesive layer 150 to be the same as the refractive index of the first resin layer 130.

Reference is made to FIG. 1. The manufacturing method of the display device further includes disposing the second optical adhesive layer 160, the touch panel 200, and the cover 300 on the second resin layer 140. The refractive index of the second optical adhesive layer 160 is the same as the refractive index of the first optical adhesive layer 150.

According to the above steps, it can be seen that the effects produced by the steps of embossing the first resin layer 130 and embossing the second resin layer 140 are not the same. The knife marks produced on the first resin layer 130 in the embossing step are produced when leveling the mold 400, and such knife marks won't affect the display by mating the refractive index of the first resin layer 130 and the refractive index of the first optical adhesive layer 150. In addition, the first resin layer 130 is provided to form the light guide entrance 132 on the thinned light guide plate 120, rather than simply to guide light. The microstructures 142 formed on the second resin layer 140 is used to guide light. Therefore, the refractive index of the second resin layer 140 must be different from the refractive index of the second optical adhesive layer 160 located above it to provide such effect. Accordingly, it can be seen that the present disclosure is not simply providing microstructures on both opposite sides of the light guide plate 120, but providing effects of light guiding and mura elimination by disposing resin layers with different refractive indexes to improve the light incident efficiency of the thinned light guide plate.

In summary, the first resin layer disposed between the light guide plate and the reflective display panel of the present disclosure is used to form the light guide entrance of the thinned light guide plate, and therefore the fringes appear on the display screen caused by the refraction of the light due to knife marks or processing defects on the first resin layer can be eliminated by matching the refractive index of the first resin layer and the refractive index of the optical adhesive layer. Therefore, effects of mura elimination and light guiding are provided respectively through disposing the first resin layer and the second resin layer that have different refractive indexes on opposite sides of the light guide plate. The present disclosure is not simply providing microstructures on both opposite sides of the light guide plate, but providing effects of mura elimination and light guiding by disposing resin layers with different refractive indexes to improve the light incident efficiency of the thinned light guide plate.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A display device, comprising:
a reflective display panel;
a light guide plate comprising a top surface and a bottom surface;
a first resin layer comprising a light guide entrance and a leveled region, wherein the first resin layer is located on the bottom surface;
a second resin layer located on the top surface and comprising a microstructure; and
a first optical adhesive layer located between the reflective display panel and the first resin layer, wherein a refractive index of the leveled region of the first resin layer and a refractive index of the first optical adhesive layer are the same.

2. The display device of claim 1, wherein the thickness of the light guide plate is less than 250 micrometers.

3. The display device of claim 1, wherein the refractive index of the first resin layer is in a range from 1.45 to 1.51.

4. The display device of claim 1, wherein a refractive index of the light guide entrance of the first resin layer is the same as the refractive index of the first optical adhesive layer.

5. The display device of claim 1, wherein a refractive index of the first resin layer is different from a refractive index of the second resin layer.

6. The display device of claim 1, wherein the refractive index of the second resin layer is the same as a refractive index of the light guide plate.

7. The display device of claim 1, wherein the refractive index of the first resin layer is smaller than the refractive index of the light guide plate.

8. The display device of claim 1, further comprising:
a cover having a display area and a non-display area, wherein an orthogonal projection of the leveled region of the first resin layer on the cover is in the display area.

9. The display device of claim 8, wherein an orthogonal projection of the light guide entrance of the first resin layer on the cover is located in the non-display area.

10. The display device of claim 1, wherein the thickness of the leveled region is smaller than the thickness of the light guide entrance.

11. The display device of claim 1, further comprising:
a light source disposed at a light incident surface of the light guide plate, and the light guide entrance is located at a side of the first resin layer adjacent to the light incident surface.

12. A manufacturing method of a display device, comprising:
coating a first resin layer on a lower surface of a light guide plate;
embossing the first resin layer with a mold to form a light guide entrance and a leveled region; and
adhering the first resin layer and a reflective display panel through a first optical adhesive layer, wherein a refractive index of the first optical adhesive layer is the same as a refractive index of the first resin layer.

13. The manufacturing method of the display device of claim 12, further comprising:
leveling the mold through a knife.

14. The manufacturing method of the display device of claim 13, wherein the first resin layer does not have a microstructure for guiding light to the reflective display panel.

15. The manufacturing method of the display device of claim 12, further comprising:
coating a second resin layer on an upper surface of the light guide plate, wherein a refractive index of the second resin layer is different from the refractive index of the first resin layer; and
forming a microstructure on the second resin layer.

16. The manufacturing method of the display device of claim 15, further comprising:
making the refractive index of the second resin layer the same as a refractive index of the light guide plate.

17. The manufacturing method of the display device of claim 15, further comprising:
adhering a second resin layer and a touch panel through a second optical adhesive layer.

18. The manufacturing method of the display device of claim 12, further comprising:
disposing a cover having a display area and a non-display area, wherein an orthogonal projection of the light guide entrance of the first resin layer on the cover is in the non-display area.

19. The manufacturing method of the display device of claim 18, further comprising:
making an orthogonal projection of the leveled region of the first resin layer on the cover in the display area.

20. The manufacturing method of the display device of claim 12, further comprising:
disposing a light source at a light incident surface of the light guide plate, wherein the light guide entrance is located at a side of the first resin layer adjacent to the light incident surface.
